(19) United States
(12) Patent Application Publication
(10) Pub. No.: US 2007/0237239 A1
(43) Pub. Date: Oct. 11, 2007

(54) Methods and apparatuses for encoding and decoding a video data stream

(76) Inventors: Byeong-Moon Jeon, Seoul (KR); Ji-Ho Park, Seoul (KR); Seung-Wook Park, Seoul (KR)

Correspondence Address: HARNESS, DICKEY & PIERCE, P.L.C., P.O. BOX 8910, RESTON, VA, 20195, US

(21) Appl. No.: 11/543,078

(22) Filed: Oct. 5, 2006

Related U.S. Application Data
(60) Provisional application No. 60/785,387, filed on Mar. 24, 2006.

(30) Foreign Application Priority Data
Aug. 22, 2006 (KR) 10-2006-0079393

(51) Int. Cl. H04N 11/02; H04N 7/12; H04N 11/04; H04B 1/66

(52) U.S. Cl. 375/240.24; 375/240.25

(57) ABSTRACT

In one embodiment, data from a data stream is parsed into a sequence of data blocks on a cycle-by-cycle basis such that at least one data block earlier in the sequence is skipped during a cycle if a data block later in the sequence includes an empty data location closer to DC components than in the earlier data block. In another embodiment, the method includes parsing data from a sequence of data blocks into a data stream on a cycle-by-cycle basis such that at least one data block earlier in the sequence is skipped during a cycle if data closer to DC components exists in a data block later in the sequence.

### DOMESTIC PRIORITY INFORMATION

This application claims the benefit of priority on U.S. Provisional Application No. 60/785,387 filed Mar. 24, 2006; the entire content of which is hereby incorporated by reference.

### FOREIGN PRIORITY INFORMATION

This application claims the benefit of priority on Korean Patent Application No. 10-2006-______, filed ______; the entire content of which is hereby incorporated by reference.

### BACKGROUND OF THE INVENTION

1. Field of the Invention

The present invention relates to technology for coding video signals in a Signal-to-Noise Ratio (SNR) scalable manner and decoding the coded data.

2. Description of the Related Art

A Scalable Video Codec (SVC) scheme is a video signal encoding scheme that encodes video signals at the highest image quality, and that can represent images at low image quality even though only part of a picture sequence (a sequence of frames that are intermittently selected from among the entire picture sequence) resulting from the highest image quality encoding is decoded and used.

An apparatus for encoding video signals in a scalable manner performs transform coding, for example, a Discrete Cosine Transform (DCT) and quantization, on data encoded using motion estimation and predicted motion, with respect to each frame of received video signals. In the process of quantization, information is lost. Accordingly, a signal encoding unit in the encoding apparatus as illustrated in FIG. 1A, obtains a difference between the original data and the encoded data by performing inverse quantization 11 and an inverse transform 12 on the encoded data and subtracting this encoded data from the original data. The encoder then generates SNR enhancement layer data D10 in a DCT domain by performing a DCT transform and quantization on the difference. By providing the SNR enhancement layer data to improve an SNR as described above, image quality is gradually improved as the decoding level of the SNR enhancement layer data increases. This is referred to as Fine Grained Scalability (FGS). Furthermore, the FGS coder 13 of FIG. 1A performs coding on the SNR enhancement layer data to convert and parse the data into a data stream. The coding is performed with a significance data path (hereinafter referred to as a ‘significance path’) and a refinement data path (hereinafter referred to as a ‘refinement path’) distinguished from each other. In a significance path, SNR enhancement layer data, with co-located data of an SNR base layer having a value of 0, is coded according to a first scheme, while in a refinement path, SNR enhancement layer data, with co-located data of the SNR base layer having a value other than 0, is coded according to a second scheme.

FIG. 1B illustrates a process in which a significance path coding unit 13a codes data on a significance path. With respect to SNR enhancement layer pixel data, in every cycle, a process of acquiring a data stream (significance data 103a), which lists data not including refinement data along a predetermined zigzag scanning path 102, while selecting 4×4 blocks in the selection sequence 101 illustrated in FIG. 1B, is performed. This data stream is coded using a method for which the number of runs of 0's is specified, for example, S3 code. Data other than 0 is coded later using a separate method.

FIG. 1C illustrates a process in which the significance path coding unit 13a performs coding while selecting each block in each cycle as a specific example. Data value 1 in a block, which is illustrated in FIG. 1C as an example, does not represent an actual value, but represents a simplified indication of a value other than 0 in the case where a Discrete Cosine Transform coefficient has a nonzero value. The notation of the values of data in blocks described below is the same.

The process illustrated in FIG. 1C as an example is described in brief below. The significance path coding unit 13a performs a first cycle for each block by sequentially listing data about 0 (112₁) (since refinement data having a value other than 0 is not target data, refinement data is excluded), and is read along a predetermined zigzag scan path until 1 is encountered, while selecting respective blocks in the sequence of selection of blocks illustrated in FIG. 1B. The significance path coding unit 13a performs a second cycle for each block by sequentially listing data about 0 (112₂) while sequentially selecting blocks and performing scanning from a location next to the last location of the first cycle along the scan path until a location having a 1 is encountered. This process is repeated for additional cycles until the data is encoded. The significance path coding unit 13a then generates a data stream 120 by listing data in the sequence of cycles while repeatedly performing the same process on all data in a current picture. This data stream may be accompanied by another coding process as mentioned above.

In the above-described coding, data coded first in the sequence of cycles are first transmitted. Meanwhile, a stream of SNR enhancement layer data (hereinafter abbreviated as ‘FGS data’) may be cut during transmission in the case where the bandwidth of a transmission channel is narrow. In this case, a large amount of data, which pertains to data 1 affecting the improvement of video quality and is closer to a DC component, is cut.

### SUMMARY OF THE INVENTION

The present invention relates to a method of decoding video data.

In one embodiment, data from a data stream is parsed into a sequence of data blocks on a cycle-by-cycle basis such that at least one data block earlier in the sequence is skipped during a cycle if a data block later in the sequence includes an empty data location closer to DC components than in the earlier data block.

In one embodiment, each data block includes a number of data locations, and an order of data locations follows a zig-zag path beginning from an upper left-hand corner of the data block. An example of the parsing step, in a first cycle, includes filling a first data section along the zig-zag path in a first data block of the sequence. The first data section is filled starting with the beginning data location and ending at a first data location along the zig-zag path filled with data corresponding to a non-zero data value. This filling operation is repeated for each subsequent block in the sequence.

In one embodiment, the parsing, in each subsequent cycle, includes determining which data blocks in the sequence have empty data locations closest to DC components.

A next data section along the zig-zag path in each determined data block is filled staring with a next data location after the filling end data location of a previously filled data section and ending at a next data location along the zig-zag path filled with data corresponding to a non-zero data value However, filling of data blocks for a current cycle that were not determined data blocks is skipped.

In one embodiment, the parsing, in each subsequent cycle, includes for each data block in the sequence, comparing a filling end data location indicator for the data block with a cycle indicator. The filling end data location indicator indicates a last filled data location along the zig-zag path in the data block, and the cycle indicator indicates a current cycle. If the comparison indicates that the filling end data location indicator is less than the cycle indicator, a next data section along the zig-zag path in the data block is filled starting with a next data location after the filling end data location of a previously filled data section and ending at a next data location along the zig-zag path filled with data corresponding to a non-zero data value. If the filling end data location indicator is greater than or equal to the cycle indicator, filling of the data block for the current cycle is skipped.

In another embodiment, the parsing, in each subsequent cycle, includes for each data block in the sequence, determining if a data location corresponding to a current cycle in the data block has been filled. If the data location corresponding to the current cycle in the data block has not been filled, a next data section along the zig-zag path in the data block is filled starting with a next data location after the filling end data location of a previously filled data section and ending at a next data location along the zig-zag path filled with data corresponding to a non-zero data value. If the data location corresponding to the current cycle in the data block has been filled, the data block for the current cycle is skipped.

In one embodiment, the sequence of data blocks represents an enhanced layer of video data associated with a base layer of video data, and the enhanced layer of video data is for enhancing the video represented by the base layer of video data. Also, a data location of a data block corresponds to a non-zero data value if a corresponding data location in the base layer of video data includes a non-zero data value.

In one embodiment, the data represents transform coefficient information.

The present invention also relates to a method of coding video data.

In one embodiment, the method includes parsing data from a sequence of data blocks into a data stream on a cycle-by-cycle basis such that at least one data block earlier in the sequence is skipped during a cycle if data closer to DC components exists in a data block later in the sequence.

The present invention further relates to apparatuses for decoding a data stream, and to apparatuses for encoding a data stream.

### BRIEF DESCRIPTION OF THE DRAWINGS

The above and other objects, features and advantages of the present invention will be more clearly understood from the following detailed description taken in conjunction with the accompanying drawings, in which:

FIG. 1A is a diagram schematically illustrating a conventional apparatus for encoding video signals with emphasis on the coding of FGS data;

FIG. 1B is a diagram illustrating an example of a conventional process of coding a picture having FGS data;

FIG. 1C is a diagram illustrating a conventional method of coding FGS data into a data stream;

FIG. 2A is a diagram schematically illustrating an apparatus for encoding video signals according to an embodiment of the present invention, with emphasis on the coding of FGS data;

FIG. 2B is a diagram illustrating the operation of prediction for a picture, which is performed by the apparatus of FIG. 2A,

FIG. 3 is a flowchart illustrating a method of coding respective blocks within a picture while scanning the blocks according to an embodiment of the present invention;

FIG. 4 is a diagram illustrating a process of scanning or skipping respective blocks according to the method of FIG. 3 as an example;

FIG. 5 is a diagram illustrating a process of arranging data close to DC components in the forward part of an encoded data stream according to the method of FIG. 3 in comparison with that of the conventional method; and

FIG. 6 is a diagram schematically illustrating an apparatus for decoding a data stream encoded by the apparatus of FIG. 2A.

### DETAILED DESCRIPTION OF EXAMPLE EMBODIMENTS

Reference will be made to the drawings, in which the same reference numerals are used throughout the different drawings to designate the same components.

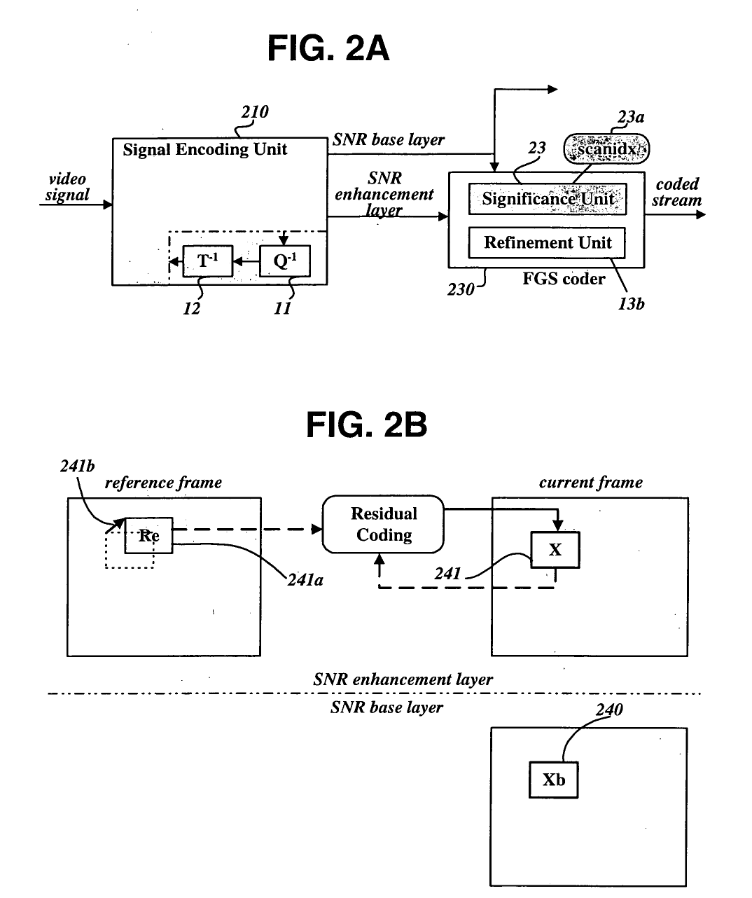

FIG. 2A illustrates an encoding apparatus for performing an encoding method according to an embodiment of the present invention. An encoder 210 shown in FIG. 2A encodes input signals, thereby generating SNR base layer data and SNR enhancement layer data (FGS data). Since the generation of t he SNR base layer data is not related to the present invention and is well-known, a description thereof is omitted here for the sake of brevity. The generation of the FGS data is performed as described below.

The encoder 210 acquires a difference (data used to compensate for errors occurring at the time of encoding) from encoded data by performing inverse quantization 11 and an inverse transform 12 on previously encoded SNR base layer data (if necessary, magnifying inversely transformed data), and obtaining a difference between this data and the original base layer data (same as previously described in the Background). As illustrated in FIG. 2B, with respect to each macroblock 241 of a frame obtained in the above-described manner, a reference block 241a is found and a motion vector 241b to the reference block 241 is obtained. When the reference block 241a is found, the encoder 210 codes difference data (residual data) between data in the reference block 241a and data in the current macroblock 241 as a residual current block. In this case, data in a block 240 in an SNR base layer, which is co-located with the current macroblock 241, is not used for the coding of the difference data. But the present invention is not limited to not using the collocated block in the SNR base layer. Furthermore, appropriate coding is performed on the obtained vector 241b. When a frame is coded into residual data in the above-described manner, FGS data in a DCT domain is generated by sequentially performing a DCT transform and quantization on the encoded residual frame, and the result is the FGS data applied to a following FGS coder 230.

To perform an FGS coding method to be described later, the significance path coding unit 23 of the FGS coder 230 manages a variable scan identifier scanidx 23a for tracing the location of a scan path on a block. The variable scanidx is only an example of the name of a location variable (hereinafter abbreviated as a ‘location variable’) on data blocks, and any other name may be used therefor.

An appropriate coding process is also performed on SNR base data encoded in the apparatus of FIG. 2A. This process is not directly related to the present invention, and therefore an illustration and description thereof are omitted here for the sake of clarity.

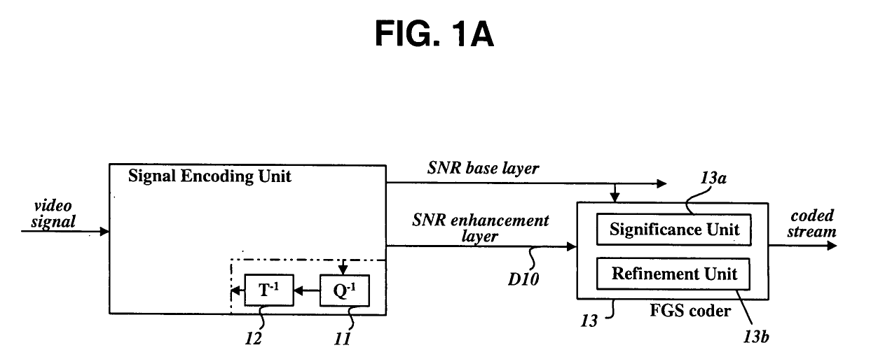

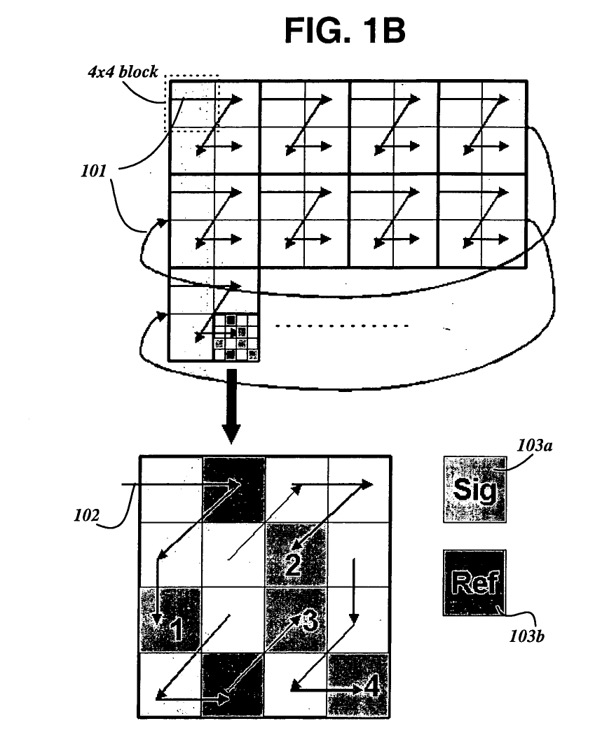

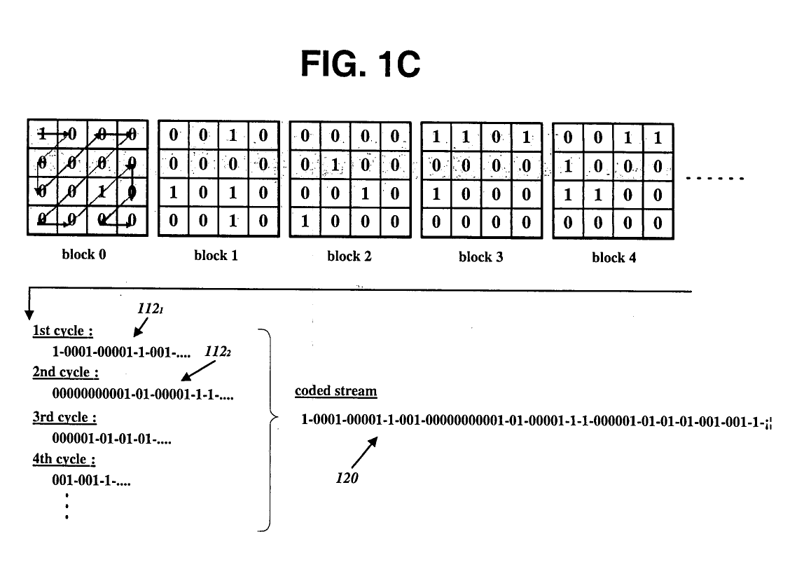

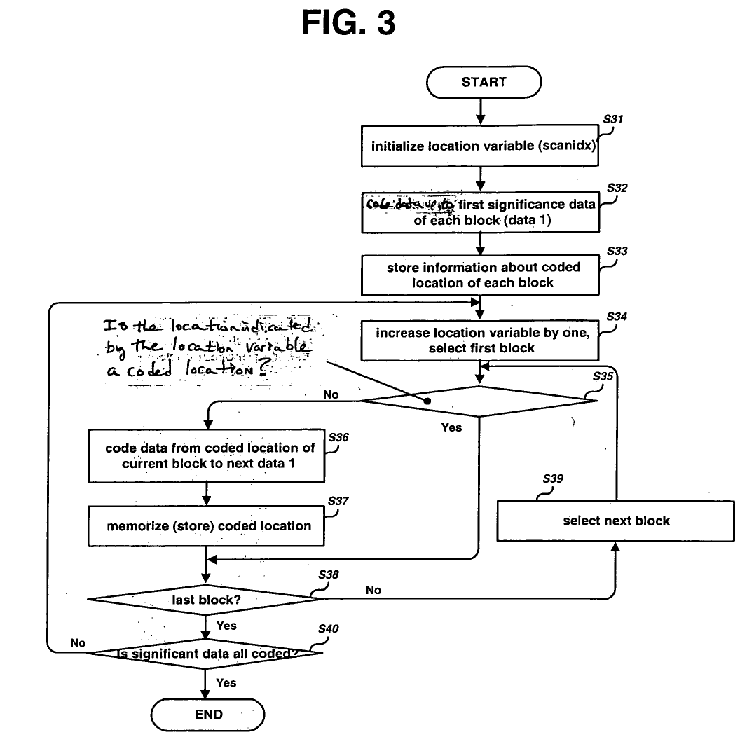

The significance path coding unit 23 of FIG. 2A sequentially selects 4×4 blocks for a single picture (which may be a frame, a slice or the like) in the manner illustrated in FIG. 1B, and codes data in a corresponding block according to a flowchart illustrated in FIG. 3, which will be described below. This process, as described below, parses data from the data blocks into a data stream. Of course, since the method to be described below can be applied to respective blocks even in the case where the sequence of selecting blocks is conducted in a manner other than the manner illustrated in FIG. 1B, the present invention is not limited to a particular sequence of selecting blocks.

The significance path coding unit 23 first initializes (e.g., =1) the location variable 23a at step S31. The respective blocks are selected in a designated sequence (e.g., by design choice or standard). At step S32, a data section is coded along a zigzag scan path (see FIG. 1C for example) for each selected block until data 1 (which is referred to as ‘significance data’) is encountered. The value at the last location of the data section coded for each block, that is, the location at which data 1 exists, is stored as a coded location variable sbidx (also referred to as a coding end data location indicator or other appropriate name) at step S33. As will be recalled, a data value 1 in a block, does not represent an actual value, but represents a simplified indication of a value other than 0 in the case where a Discrete Cosine Transform coefficient has a nonzero value. When the first cycle is finished, the location variable 23a is increased by one at step S34. According to the number of performed cycles, the value of the location variable 23a increases, therefore the location variable 23a indicates the number of cycles and may also be referred to as the cycle indicator.

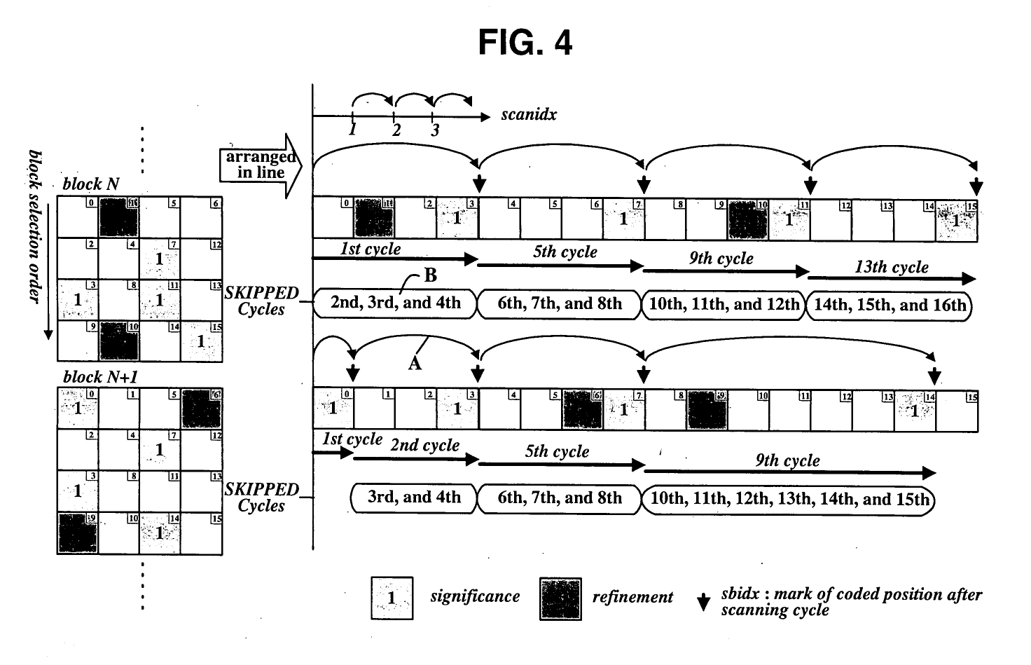

Next, a second cycle is performed starting from the first block in the designated sequence as the selected block. Whether the location currently indicated by the location variable scanidx 23a is a previously coded location is determined by comparing the coding end location indicator sbidx of a selected block with the cycle indicator scanidx 23a at step S35. Namely, if the coding end location indicator sbidx for the selected block is greater than or equal to the cycle indicator scanidx, the location in the selected block indicated by the variable scanidx has been coded. It should be remembered that the location is the location along the zig-zag path of FIG. 1B, where location “0” is the upper left hand corner and each location number along the zig-zag path is one plus the location number for the previous location on the zig-zag path. This is shown in FIG. 4, which illustrates an example of the process of FIG. 3 applied to two blocks N and N+1 in the block selection sequence. FIG. 4 also shows the order in which the data is coded for each block N and N+1 as well as the cycles during which coding takes place and the cycles skipped. In the example of FIG. 4, mark A denotes a data section on a block N+1, which is coded in the second cycle. In the example of FIG. 4, the location “2” of block N exists in the section coded in the first cycle, and therefore block N is skipped in the second cycle.

Returning to step S35, the current block is skipped if the location is a previously coded location, and the process proceeds to the subsequent step S39 if the skipped block is not the last block within the current picture at step S38. If the location currently indicated by the location variable 23a is not a coded location, coding is performed on a data section from the previously coded location (the location indicated by the variable sbidx) to the location where data 1 exists, at step S36. Of course, when the coding is completed, the coded location variable sbidx for the block is updated at step S37. If the currently coded block is not the last block at step S38, the process proceeds to the subsequent block at step S39.

The significance path coding unit 23 repeatedly performs the above-described steps S34 to S39 until all significance data is coded at step S40.

Returning to the example of FIG. 4, the block N is skipped in third and fourth cycles after the second cycle (mark B), and a data section up to significance data at location 7 on a scan path is coded in a fifth cycle.

In another embodiment according to the present invention, a temporary matrix may be created for each block and the corresponding locations of the temporary matrix may be marked for the completion of coding for coded data (for example, set to 1), instead of storing previously coded locations. In the present embodiment, when it is determined whether the current location indicated by the location variable 23a is a coded location at step S35, the determination is performed by examining whether the value at the location of the temporary matrix corresponding to the location variable is marked for the completion of coding.

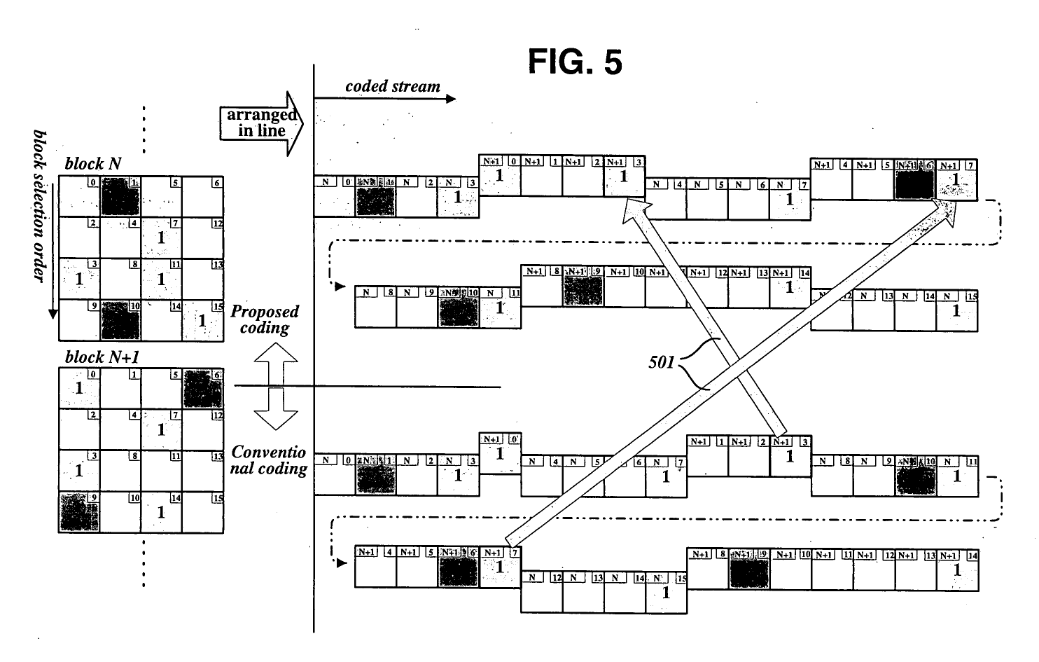

Since, in the above-described process, data coded in the preceding cycle is arranged in the forward part of a data stream, there is a strong possibility that significance data located at a forward location on a scan path will be first coded and transmitted regardless of the frequency thereof, when blocks are compared with each other. To further clarify this, FIG. 5 illustrates a data stream that is coded for two blocks N and N+1 presented in the example of FIG. 4, in comparison with a data stream based on the conventional coding method described in the Background of Invention section.

As illustrated in the example of FIG. 5, the numbers of pieces of significance data are almost the same in the same sections from the start of a coded stream, compared to those based on the conventional coding method. However, in light of the attributes of the significance data, in the coding according to the present invention, significance data placed at forward locations on the scan path of a block are located in the forward part of a coded stream, compared to the conventional method (see, for example, 501 in FIG. 5). Since the data is placed at forward locations on the scan path of a block (in FIG. 5, numbers in the right upper portions of respective blocks indicate sequential positions on the path), the data is closer to DC components than rearward data DCT coefficients. As such, the present invention transmits more significance data close to DC components on average than the conventional method in the case where transmission is interrupted. For example, data from a sequence of data blocks is parsed into a data stream on a cycle-by-cycle basis such that at least one data block earlier in the sequence is skipped during a cycle if data closer to DC components exists in a data block later in the sequence.

In another embodiment of the present invention, another value may be determined at step S35 for determining whether the location indicated by the location variable 23a is a coded location. For example, a transformed value is determined from the value of the location variable 23a. A vector may be used as a function for transforming a location variable value. That is, after the value of vector[0 . . . 15] has been designated in advance, whether the location indicated by the value of the element ‘vector[scanidx]’ corresponding to the current value of the location variable 23a is an already coded location is determined at the determination step at step S35. If the elements of the vector ‘vector[ ]’ are set to monotonically increasing values, as in {0,1,2,3,4,5,6,7,8,9,10,11,12,13,14, 15}, the process becomes the same as that of the embodiment of FIG. 3. However, if a vector is set such that a value not less than the value of a location variable scanidx is designated as a transform value with the elements of the vector ‘vector[ ]’ set to, for example, {3,3,3,3,7,7,7,7,11,11,11,11,15,15,15,15}, a data section from the coded location to subsequent data 1 is coded for the block in the case where the value ‘vector[scanidx]’, obtained by transformation via the location variable, is larger than the coded location variable sbidx of the corresponding block, even though the current location designated by the location variable 23a is already coded in each cycle.

Accordingly, by appropriately setting the value of the transform vector ‘vector[ ]’, the extent to which significance data located in the forward part of the scan path is located in the forward part of the coded stream, compared to that in the conventional method, can be adjusted.

The elements of the vector designated as described above are not directly transmitted to the decoder, but can be transmitted as mode information. For example, if the mode is 0, it indicates that the vector used is {0,1,2,3,4,5,6,7,8,9,10,11,12,13,14,15}. If the mode is 1, a grouping value is additionally used and designates the elements of a vector used. When the grouping value is 4, the same value is designated for each set of 4 elements. In more detail, when vector {3,3,3,3,7,7,7,7,11,11,11,11,15,15,15,15} is used if the mode is 1 and the grouping value is 4, and the mode and grouping information is transmitted to the decoder. Furthermore, if the mode is 2, values at the last locations of respective element groups for each of which the same value is designated are additionally used. For example, when the mode is 2 and the set of values additionally used is {5,10,15}, it indicates that the vector used is {5,5,5,5,5,5,10,10,10,10,10,15,15,15,15,15}.

A method of decoding data in a decoding apparatus receiving the data stream coded as described above is described below.

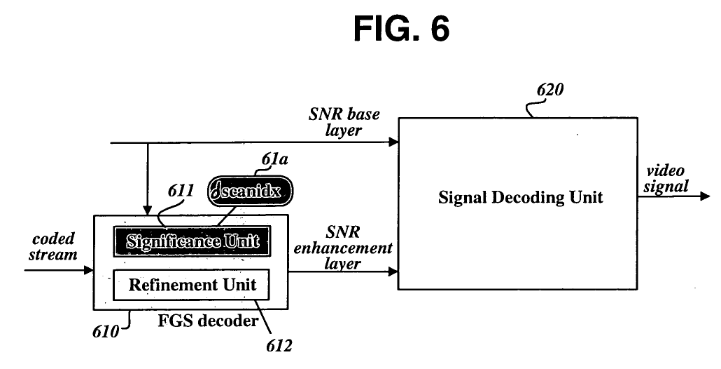

FIG. 6 is a block diagram illustrating an embodiment of an apparatus for decoding a data stream coded and transmitted by the apparatus of FIG. 2A. The data stream received by the apparatus of FIG. 6 is data that has undergone an appropriate decoding process and, thereby, has been decompressed in advance. When the stream of FGS data coded in the manner described above is received, the significance path decoding unit 611 of the FGS decoder 610 decodes a significance data stream and constructs each picture. Meanwhile, the refinement path decoding unit 612 decodes a refinement data stream and supplements each picture with the data, thereby completing the picture. Since the decoding of refinement data is not directly related to the present invention, a description thereof is omitted here for the sake of clarity.

At the time of decoding a significance data stream, the significance path decoding unit 611 performs the process of FIG. 3. That is, it performs the process in which the coding process is replaced with a decoding process in the flowchart of FIG. 3. In this process, the significance data stream is decoded or parsed into a sequence of data blocks. Namely, the significance data stream of received coded FGS data is divided into data sections to data 1, that is, a units of “0 . . . 001”, and the sequence of data blocks are filled with the data sections along a zigzag scan path on each the block. When a block is filled with the data, a location is not filled with data but is skipped in the case where the value at the corresponding location in the SNR base layer is not 0 (that is, a location in the block that is to be filled corresponds to refinement data). The skipped location is filled with data by the refinement path decoding unit 612. In the following description, filling a block with data means filling the block with data while skipping locations to be filled with refinement data.

The significance path decoding unit 611 initializes the location variable dscanidx 61a (e.g., =1) at step S31. As will be apparent, this variable may also be referred to as the cycle indicator and indicates a current cycle. For each block in designated sequence, the significance path decoding unit 611 fills a selected block with data up to data 1 from the significance data stream, for example, “0 . . . 001”, along a zigzag scan path at step S32. The value for the last location which is filled with data for each of the respective blocks, that is, the location at which data 1 is recorded, is stored in a decoded location variable dsbidx at step S33. The variable dsbidx may also be referred to as the filling end data location indicator. After the first cycle is finished, the location variable 61a is increased by one at step S34. Thereafter, a process of performing a second cycle while sequentially selecting the respective blocks starting with the first one (step S34) is conducted. By comparing the filling end data location indicator sbidx of the selected block with the cycle indicator 61a, it is determined whether the location indicated by the variable 61a is a location already filled with data at step S35. Namely, if the filling end data location indicator dsbidx is greater than or equal to the cycle indicator dscanidx, the location indicated by the location variable dscanidx contains decoded data. If the location is a location filled with data, the current block is skipped. If the skipped block is not the last block within the current picture at step S38, the process proceeds to the subsequent block at step S39. If the location indicated by the location variable 61a is not a location filled with data, a data section from the previously filled location (a location designated by dsbidx) to data 1 in the significance data stream is read, and filling is performed at step S36. Of course, when this step is completed, the decoded location variable for the block, that is, the value sbidx of the last location filled with data, is updated at step S37. Meanwhile, if the current decoded block is not the last block at step S38, the process proceeds to the subsequent block at step S39.

If the block is the last block, then the process returns to step S34, where the location variable dscanidx is incremented, and another cycle begins. The significance path decoding unit 611 repeatedly performs the above-described steps S34 to S39 on the current picture until the last significance data is filled at step S40, thereby decoding a picture. The subsequent significance data stream is used for the decoding of the subsequent picture. As will be appreciated, the method parses data from a data stream into a sequence of data blocks on a cycle-by-cycle basis such that at least one data block earlier in the sequence is skipped during a cycle if a data block later in the sequence includes an empty data location closer to DC components than in the earlier data block.

In another embodiment according to the present invention, a temporary matrix may be created for each block and the corresponding locations of the temporary matrix may be marked for the completion of decoding for coded data (for example, set to 1), instead of storing previously coded locations (locations filled with data). In the present embodiment, when it is determined whether the current location indicated by the location variable 61a is a decoded location at step S35, the determination is performed by examining whether the value at the location of the temporary matrix corresponding to the location variable is marked for the completion of decoding.

When a location filled with data is determined according to another embodiment described in the encoding process at step S35, whether a location indicated by an element value ‘vector[scanidx]’, which is obtained by substituting the value of the location variable 61a for a previously designated transform vector ‘vector[ ]’, instead of the value of the location variable 61a, is a location already filled with data may be determined. Instead of the previously designated transform vector, a transform vector is constructed based on a mode value (in the above-described example, 0, 1 or 2) received from the encoding apparatus, and information accompanying the mode value (in the case where the mode value is 1 or 2) is used.

Through the above-described process, an FGS data stream (both significance data and refinement data) is completely restored to pictures in a DCT domain and is transmitted to a following decoder 620. To decode each SNR enhancement frame, the decoder 620 performs inverse quantization and an inverse transform first, and then, as illustrated in FIG. 2B, restores the video data of a current macroblock by adding the data of a reference block, which is designated by a motion vector and was decoded in advance, to the residual data of the macroblock, with respect to the macroblock of a current frame.

The above-described decoding apparatus may be mounted in a mobile communication terminal or an apparatus for playing recording media.

The present invention, described in detail via the limited embodiments, more likely allows more data, which pertains to data affecting the improvement of video quality and which is closer to DC components, to be transmitted to the decoding apparatus, and therefore high-quality video signals can be provided on average regardless of the change of a transmission channel.

Although the example embodiments of the present invention have been disclosed for illustrative purposes, those skilled in the art will appreciate that various modifications, additions and substitutions are possible, without departing from the scope and spirit of the invention.

What is claimed is:

1. A method of decoding video data, comprising:
parsing data from a data stream into a sequence of data blocks on a cycle-by-cycle basis such that at least one data block earlier in the sequence is skipped during a cycle if a data block later in the sequence includes an empty data location closer to DC components than in the earlier data block.

2. The method of claim 1, wherein the sequence of data blocks represents signal-to-noise ratio improvement data.

3. The method of claim 1, wherein
each data block includes a number of data locations, and an order of the data locations follows a zig-zag path beginning from an upper left-hand corner of the data block;
the parsing step, in a first cycle, comprises:
filling a first data section along the zig-zag path in a first data block of the sequence, the first data section starting with the beginning data location and ending at a first data location along the zig-zag path filled with data corresponding to a non-zero data value; and
repeating the filling step for each subsequent block in the sequence.

4. The method of claim 3, wherein
the sequence of data blocks represents an enhanced layer of video data associated with a base layer of video data, the enhanced layer of video data for enhancing the video represented by the base layer of video data; and
a data location of a data block corresponds to a non-zero data value if a corresponding data location in the base layer of video data includes a non-zero data value.

5. The method of claim 3, wherein the parsing step, in each subsequent cycle, comprises:
determining which data blocks in the sequence have empty data locations closest to DC components;
filling a next data section along the zig-zag path in each determined data block starting with a next data location after the filling end data location of a previously filled data section and ending at a next data location along the zig-zag path filled with data corresponding to a non-zero data value;
skipping filling of data blocks for a current cycle that were not determined data blocks.

6. The method of claim 5, wherein
the sequence of data blocks represents an enhanced layer of video data associated with a base layer of video data, the enhanced layer of video data for enhancing the video represented by the base layer of video data; and
a data location of a data block corresponds to a non-zero data value if a corresponding data location in the base layer of video data includes a non-zero data value.

7. The method of claim 5, wherein the parsing step, in each subsequent cycle, comprises:
for each data block in the sequence,
comparing a filling end data location indicator for the data block with a cycle indicator, the filling end data location indicator indicating a last filled data location along the zig-zag path in the data block, and the cycle indicator indicating a current cycle;
filling a next data section along the zig-zag path in the data block starting with a next data location after the filling end data location of a previously filled data section and ending at a next data location along the zig-zag path filled with data corresponding to a non-zero data value if the comparing step indicates that the filling end data location indicator is less than the cycle indicator; and
skipping filling of the data block for the current cycle if the filling end data location indicator is greater than or equal to the cycle indicator.

8. The method of claim 7, wherein
the sequence of data blocks represents an enhanced layer of video data associated with a base layer of video data, the enhanced layer of video data for enhancing the video represented by the base layer of video data; and
a data location of a data block corresponds to a non-zero data value if a corresponding data location in the base layer of video data includes a non-zero data value.

9. The method of claim 5, wherein the parsing step, in each subsequent cycle, comprises:
for each data block in the sequence,
determining if a data location corresponding to a current cycle in the data block has been filled;
filling a next data section along the zig-zag path in the data block starting with a next data location after the filling end data location of a previously filled data section and ending at a next data location along the zig-zag path filled with data corresponding to a non-zero data value if the data location corresponding to the current cycle in the data block has not been filled; and
skipping filling of the data block for the current cycle if the data location corresponding to the current cycle in the data block has been filled.

10. The method of claim 9, wherein
the sequence of data blocks represents an enhanced layer of video data associated with a base layer of video data, the enhanced layer of video data for enhancing the video represented by the base layer of video data; and
a data location of a data block corresponds to a non-zero data value if a corresponding data location in the base layer of video data includes a non-zero data value.

11. The method of claim 1, wherein the data represents transform coefficient information.

12. The method of claim 1, further comprising:
receiving an enhancement layer video data stream that includes a significance data stream and a refinement data stream, the refinement data stream supplementing pictures represented by the significance data stream; and wherein
the parsing step operates on the significance data stream.

13. The method of claim 12, wherein the enhanced layer video data stream is for enhancing video represented by a base layer video stream.

14. The method of claim 13, wherein the enhanced layer video data stream represents signal-to-noise ratio improvement data.

15. A method of coding video data, comprising:
parsing data from a sequence of data blocks into a data stream on a cycle-by-cycle basis such that at least one data block earlier in the sequence is skipped during a cycle if data closer to DC components exists in a data block later in the sequence.

16. The method of claim 15, wherein the sequence of data blocks represents signal-to-noise ratio improvement data.

17. The method of claim 15, wherein
each data block includes a number of data locations, and an order of the data locations follows a zig-zag path beginning from an upper left-hand corner of the data block;
the parsing step, in a first cycle, comprises:
coding a first data section along the zig-zag path in a first data block of the sequence, the first data section starting with the beginning data location and ending at a first data location along the zig-zag path corresponding to a non-zero data value; and
repeating the coding step for each subsequent block in the sequence.

18. The method of claim 17, wherein
the sequence of data blocks represents an enhanced layer of video data associated with a base layer of video data, the enhanced layer of video data for enhancing the video represented by the base layer of video data; and
a data location of a data block corresponds to a non-zero data value if a corresponding data location in the base layer of video data includes a non-zero data value.

19. The method of claim 17, wherein the parsing step, in each subsequent cycle, comprises:
determining which data blocks in the sequence have data closest to DC components;
coding a next data section along the zig-zag path in each determined data block starting with a next data location after the coding end data location of a previously coded data section and ending at a next data location along the zig-zag path corresponding to a non-zero data value;
skipping coding of data blocks for a current cycle that were not determined data blocks.

20. The method of claim 19, wherein
the sequence of data blocks represents an enhanced layer of video data associated with a base layer of video data, the enhanced layer of video data for enhancing the video represented by the base layer of video data; and
a data location of a data block corresponds to a non-zero data value if a corresponding data location in the base layer of video data includes a non-zero data value.

21. The method of claim 19, wherein the parsing step, in each subsequent cycle, comprises:
for each data block in the sequence,
comparing a coding end data location indicator for the data block with a cycle indicator, the coding end data location indicator indicating a last coded data location along the zig-zag path in the data block, and the cycle indicator indicating a current cycle;
coding a next data section along the zig-zag path in the data block starting with a next data location after the coding end data location of a previously coded data section and ending at a next data location along the zig-zag path corresponding to a non-zero data value if the comparing step indicates that the coding end data location indicator is less than the cycle indicator; and
skipping coding of the data block for the current cycle if the coding end data location indicator is greater than or equal to the cycle indicator.

22. The method of claim 21, wherein
the sequence of data blocks represents an enhanced layer of video data associated with a base layer of video data, the enhanced layer of video data for enhancing the video represented by the base layer of video data; and
a data location of a data block corresponds to a non-zero data value if a corresponding data location in the base layer of video data includes a non-zero data value.

23. The method of claim 19, wherein the parsing step, in each subsequent cycle, comprises:
for each data block in the sequence,
determining if a data location corresponding to a current cycle in the data block has been coded;
coding a next data section along the zig-zag path in the data block starting with a next data location after the coding end data location of a previously coded data section and ending at a next data location along the zig-zag path corresponding to a non-zero data value if the data location corresponding to the current cycle in the data block has not been coded; and
skipping coding of the data block for the current cycle if the data location corresponding to the current cycle in the data block has been coded.

24. The method of claim 23, wherein
the sequence of data blocks represents an enhanced layer of video data associated with a base layer of video data, the enhanced layer of video data for enhancing the video represented by the base layer of video data; and
a data location of a data block corresponds to a non-zero data value if a corresponding data location in the base layer of video data includes a non-zero data value.

25. An apparatus for decoding a data stream comprising:
a decoder including at least one parsing unit, the parsing unit parsing data from a data stream into a sequence of data blocks on a cycle-by-cycle basis such that at least one data block earlier in the sequence is skipped during a cycle if a data block later in the sequence includes an empty data location closer to DC components than in the earlier data block.

26. An apparatus for encoding a data stream, comprising:
an encoder including at least a first paring unit parsing data from a sequence of data blocks into a data stream on a cycle-by-cycle basis such that at least one data block earlier in the sequence is skipped during a cycle if data closer to DC components exists in a data block later in the sequence.

27. A method of decoding a data stream, comprising:
parsing transform coefficient data from a data stream into a data block on a cycle-by-cycle basis, such that at least one component in the data block closer to a DC component is parsed first.

28. The method of claim 27, further comprising:
inverse-quantizing the data block.

29. The method of claim 28, further comprising:
inverse-transforming the data block.

30. The method of claim 27, wherein the at least one component includes one of a non-zero transform coefficient data and a zero transform coefficient data.
